(19) United States
(12) Patent Application Publication
(10) Pub. No.: US 2026/0162063 A1
(43) Pub. Date: Jun. 11, 2026

(54) SYSTEM AND METHOD FOR IMMEDIATELY DETECTING REMOVAL AND ENABLING REAL-TIME RECOVERY OF CARGO

(71) Applicant: SkyMirr, Inc., Melbourne, FL (US)

(72) Inventors: Kerry Greer, Melbourne, FL (US); Youngmin JO, Melbourne, FL (US)

(21) Appl. No.: 19/413,532

(22) Filed: Dec. 9, 2025

Related U.S. Application Data
(60) Provisional application No. 63/729,507, filed on Dec. 9, 2024.

(51) Int. Cl. G06Q 10/087

(52) U.S. Cl. CPC G06Q 10/0877

(57) ABSTRACT

A cargo management system for tracking a pallet and containers carried on the pallet. An asset tracking management software application is provided with status information regarding the pallet and the containers. A pallet communications device sends pallet status signals, including pallet location, to the software application. Certain ones of the containers, via a container communications device, send container status signals, including container location, directly to the software application. Certain other ones of the containers can communicate only with the pallet communications device via a Bluetooth link. These containers are interrogated to ascertain whether they are on the pallet based on whether a reply signal is received and based thereon the container location can be determined. An owner of the containers can access the software application to determine pallet and container locations and thus determine whether a pallet or container has been diverted from its intended destination.

### CROSS REFERENCE TO RELATED APPLICATIONS

The present application claims priority under 35 U.S.C. 119(e) to the provisional patent application filed on Dec. 9, 2024 and assigned application No. 63/729,507 (Attorney Docket 16514-013P). The contents of that application are incorporated herein.

### FIELD OF THE INVENTION

This invention relates to systems and methods for cargo monitoring, and more specifically, to a system and method that detects unauthorized removal or misdirection of cargo and enables real-time tracking and recovery for lost or stolen cargo.

### BACKGROUND OF THE INVENTION

It is a well-known constraint to commercial logistics shipment tracking that cargo being tracked is generally monitored at the trailer level, where it is tracked by following the trailer that is carrying the cargo. Considering this, there is a large and growing problem where entire truckloads of cargo are misdirected by fake shipping companies using false paperwork and ultimately delivered to an address unbeknown to the owner of the cargo. The owner is completely reliant on false trailer location information during transport of the cargo.

It is further known that when individual boxes or pallets are tracked, the tracking devices are set to transmit their position at periodic intervals. As such, when pallets or boxes are removed from their transport trailer, the owner of the cargo may not receive timely notification of the removal.

Another limitation of current systems is that when cargo is stolen from a trailer the entire pallet may not taken from the trailer. Instead, individual cargo boxes are removed from their host pallets within trailer. Therefore, tracking pallets alone (tracking at the pallet level) cannot determine that an individual cargo box has been removed from the trailer.

Another limitation of current tracking devices is their battery life. These devices are set to transmit at fixed intervals. There is a trade-off between the frequency of repeated cellular transmissions and battery life. When these devices are set to transmit frequently, the battery discharges very quickly. Alternatively, when they are set to transmit infrequently, they cannot provide adequate real-time position updates.

Still another limitation of current embedded tracking devices is their inability to close a communications link to the 4G/5G cellular network when inside the trailer, especially when the back door of the trailer is closed.

### SUMMARY OF THE INVENTION

The Applicant's invention described herein allows an owner/shipper of goods direct visibility to the cargo location, thereby providing an independent shipping/tracking mechanism regardless of the location of the shipping trailer carrying the goods. Additionally, this visibility is provided from the beginning to the end of the shipping journey.

The Applicant's invention further provides a method and system capable of real-time detection of removal of either a cargo pallet or an individual box (also referred to more generally as a container) from a pallet and then from the shipping trailer.

The method and system also provide immediate notification of the removal and then provides real-time pallet or box location tracking data to the owner of the goods to facilitate timely recovery.

Applicant's invention further conserves and maximizes battery life by transmitting location information only when necessary.

Applicant's invention also improves connectivity to the external 4G/5G cellular networks (also referred to as a wide area network (WAN)) while the communications devices (mounted or carried on shipping boxes and pallets) are within the trailer. A cloud-hosted asset tracking dashboard is available for use by the owner of the goods. The owner logs into their account and the dashboard provides status and location information for all pallets and boxes throughout the world.

The preferred embodiment of this system and method comprises four separate components: 1) one or more pallet-embedded communication nodes (or “pallet modules”), 2) one or more enhanced box-mounted communication nodes (or “enhanced box modules”), 3) one or more simplified box-mounted communication nodes (or “simplified box modules”), and 4) a pallet and box management component, also referred to as an asset tracking management component that displays the tracking information in a dashboard format.

Each pallet module is configured with a microcontroller, a battery, a memory, a 4G/5G cellular messaging interface, a local wireless interface or LAN (e.g., Bluetooth and/or WiFi network), a global navigation satellite system (GNSS) location-determining component, and a MulCAT high gain antenna system (multi-layer coupling-controlled antenna system) for communicating with the enhanced box modules and simplified box modules via Bluetooth and WiFi communications paths. The pallet module is configured with a plurality of sensors as further described herein.

The MulCAT high gain antenna system is described in pending co-owned patent applications: (1) Multi-Layer Coupling-Controlled Ultra Compact Antenna System, filed Jun. 19, 2024 and assigned application number Ser. No. 18/747,795 (Attorney Docket Number 16514-007), and (2) Helical-Shaped Coupling-Controlled Compact Antenna System, filed Jun. 19, 2024 and assigned application number Ser. No. 18/747,799 (Attorney Docket 16514-009), both of which are incorporated herein by reference. The MulCAT antenna system supports and improves connection to the 4G/5G cellular network, especially when a pallet or box module is within the shipping trailer. The MulCAT antenna system also supports and improves connection to LAN devices (other pallet modules, enhanced box modules, and simplified box modules) within the shipping trailer.

Each enhanced box module is configured with a microcontroller, a battery, a memory, and a local wireless or LAN interface (either Bluetooth or WiFi connectivity or both Bluetooth and WiFi connectivity). The enhanced box modules additionally contain a GNSS location-determining device and a 4G/5G cellular messaging interface.

Each simplified box module is configured with a Bluetooth communications interface (for transmitting and receiving) and a battery.

The pallet module communicates with enhanced box modules via a WiFi interface and communicates with simplified box modules via a Bluetooth wireless interface.

Connectivity from the pallet and box communications modules to the asset tracking management component is accomplished via 4G/5G connection paths.

An owner or shipper of the goods can access the web-based asset tracking management component and the associated asset tracking cloud-hosted dashboard via any WAN Internet connection.

It is an object of this invention to provide pallet-level and box-level tracking of goods (cargo containers) independently from tracking of the shipping trailer that transports the goods.

It is another object of this invention to detect when a box has been removed from its host pallet and to provide notification of this removal to the asset tracking management component (and thereby to the owner of the goods) within about 3 minutes.

It is another object of this invention to provide notification of pallet removal from the shipping trailer within about 3 minutes. Notification is sent to the asset tracking management component for display on the asset tracking dashboard.

If cargo is removed from the trailer before reaching its destination, it is another object of the invention to provide real-time cargo (pallet or box) location tracking updates that are accurate to about 10 feet. The updates are provided at about three-minute intervals.

It is another object of the invention to conserve module battery life by avoiding transmission of information when unnecessary.

It is another object of the invention to improve cellular connectivity for the pallet and box modules from inside the shipping trailer.

### BRIEF DESCRIPTION OF THE DRAWINGS

FIG. 1 is a block diagram of the system of the invention and especially the signal paths between the various system components, with the enhanced and simplified box modules shown in abbreviated form and the pallet module shown in more detail.

FIG. 2 is a detailed block diagram of the pallet module.

FIG. 3 is a block diagram of an enhanced box module.

FIG. 4 is a block diagram of a simplified box module.

FIG. 5 is a block diagram of the pallet and box management component.

FIG. 6 is an image of a shipping trailer utilizing modules in accordance with the present invention.

FIG. 7A is block diagram of a shipping pallet carrying several shipping boxes in accordance with the present invention; FIGS. 7B and 7C are simplified block diagrams of a shipping box carrying an enhanced box module and a shipping box carrying a simplified box module, respectively.

### DETAILED DESCRIPTION OF THE INVENTION

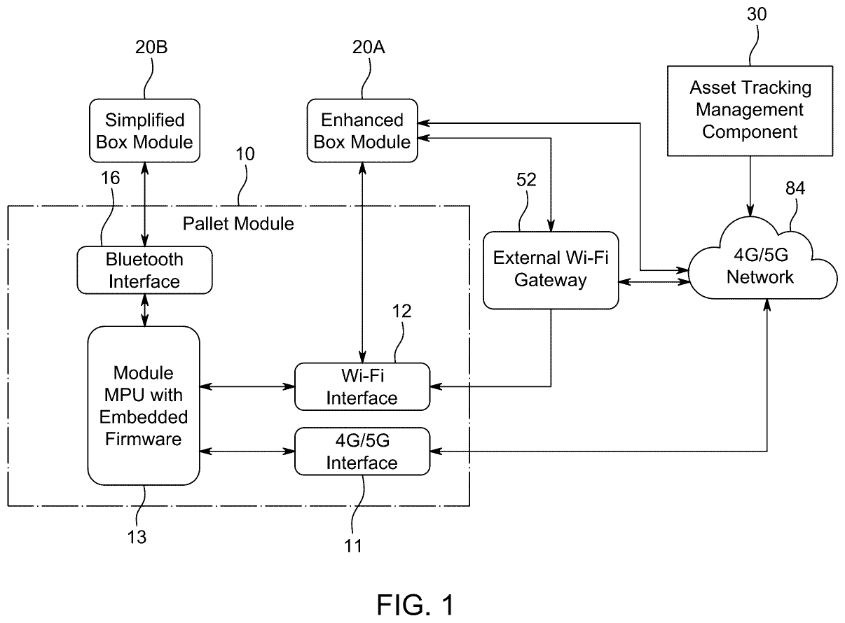

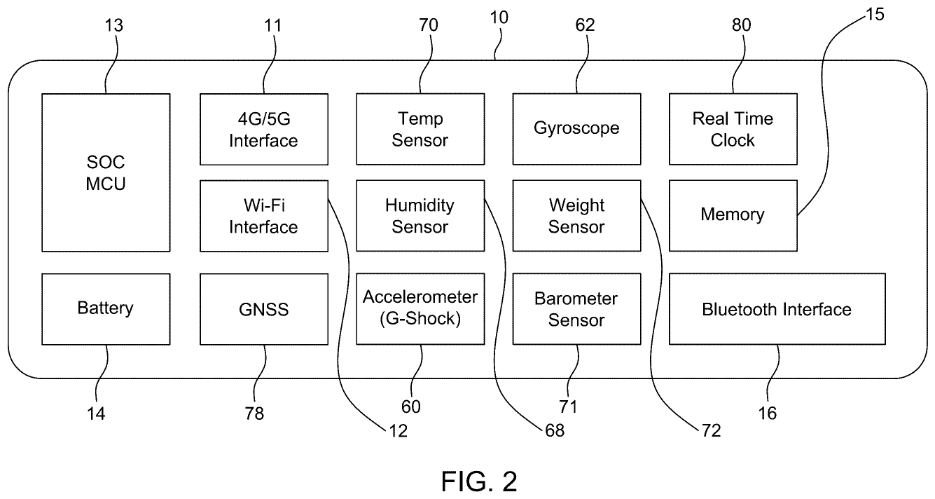

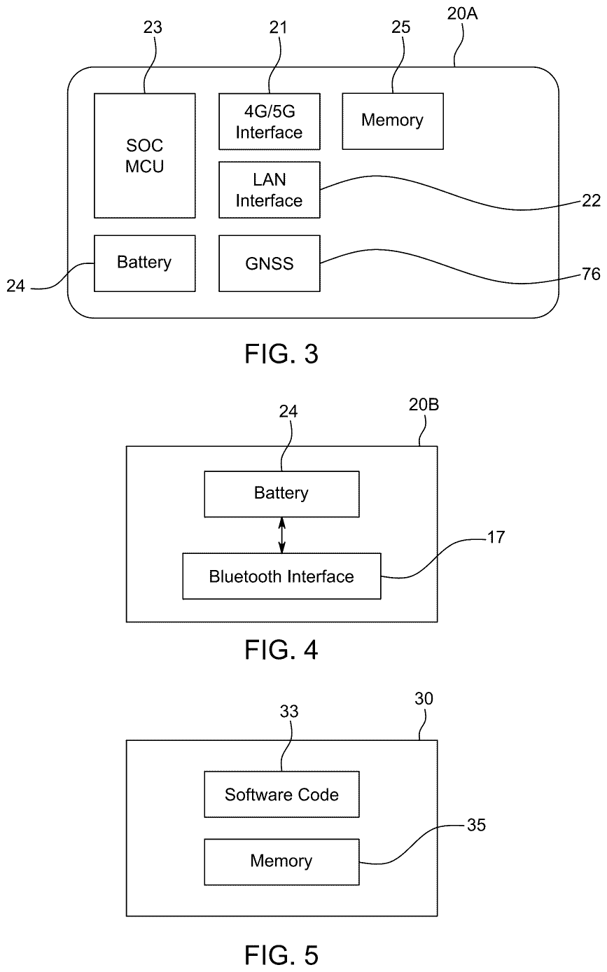

The preferred embodiment of this system and method comprises four separate components: 1) one or more pallet-embedded communications nodes or pallet communications modules 10 (also referred to as pallet modules) illustrated in FIG. 2; 2) one or more enhanced box-mounted communications nodes (also referred to as enhanced box modules) 20A illustrated in FIG. 3; 3) one or more simplified box-mounted communications nodes (also referred to as simplified box modules) 20B illustrated in FIG. 4; and 4) a software-based pallet and box asset tracking management component 30 (see FIG. 1) that includes a web-based interface. Users log-in to the interface and can see information regarding their pallets and boxes (and the associated modules). However, the user cannot access information about pallets and boxes of other users. The asset tracking management component is also referred to as an asset tracking dashboard and a UI (user interface) dashboard. See FIG. 5.

As used herein, a communications interface (e.g., a Bluetooth interface, a 4G/5G interface) refers to a receiver and transmitter pair for sending and receiving signals according to the applicable communications protocol.

Note also that the various block diagrams depict internal functional blocks. These internal functional blocks are interconnected as known by those skilled in the art; these interconnections are not shown in the block diagrams to avoid cluttering the diagram.

The various and multiple communications paths provided by the invention, further described herein, allow an enhanced box module (carried on some of the shipping boxes or shipping containers) to communicate directly with the external 4G/5G network or to communicate with the external 4G/5G network via communications components of the pallet module. These redundant communications paths provide alternative paths for reaching the asset tracking management component 30.

The shipping boxes equipped with a simplified box communications module communicate with the external 4G/5G network only via the communications components on the pallet module.

The pallet module communicates with the external 4G/5G network directly or via a WiFi gateway carried on the shipping tailer.

According to conventional shipping practices, a plurality of boxes is carried on a pallet and a plurality of pallets is carried by a shipping trailer or another carriage vehicle. The pallet module and the box modules of the present invention, operating in conjunction with the dashboard, allow tracking of pallets and boxes during shipping.

FIG. 1 illustrates the principal communications components and the communications links between them.

The WiFi interface 12 of the pallet module communicates with an external WiFi gateway 52, which in turn communicates with a 4G/5G network 84. In one embodiment, the WiFi gateway 52 represents a WiFi gateway on a truck or shipping trailer transporting the pallets.

The 4G/5G interface 11 of the pallet module can also communicates directly with the 4G/5G network 84, which is especially beneficial if the truck or shipping trailer lacks a WiFi gateway, such as the external WiFi gateway 52.

The enhanced box module 20A can communicate directly with the 4G/5G network 84 as shown.

Alternatively, a signal from the enhanced box module 20A is input to the WiFi interface 12 of the pallet module, to the external WiFi gateway 52, and finally to the 4G/5G network 84.

According to yet another communication alternative, the enhanced box module can communicate directly with the WiFi gateway 52 if necessary. However, this is not the preferred communication path and is used only if a box and its enhanced box module are shipped separately from a pallet and its pallet module.

The simplified box module 20B comprises a Bluetooth interface 17 for receiving Bluetooth signals from the pallet module 10. The simplified box module does not transmit information. Instead, the pallet module 10 pings or queries the box module 20B via the Bluetooth interface 16 to determine if the box module is within range. Receiving a reply signal indicates that the box and its simplified box module are on the pallet.

If the simplified box module fails to acknowledge receipt of the ping signal, i.e., the Bluetooth interface 16 fails to receive a reply signal, the pallet module creates and transmits a signal to the asset tracking management component 30 that the box is not within range. This signal can be sent (see FIG. 1) from a system on a chip (SOC) master control unit 13, the WiFi interface 12, the external WiFi gateway 52, finally reaching the 4G/5G network 84, and the asset tracking management component 30.

Alternatively, the pallet module signal (indicating that the simplified box module failed to respond to the interrogation signal) is transmitted to the 4G/5G network 84 (and thus made available to the asset tracking and management component 30) via the SOC master control unit 13, and the 4G/5G interface 11.

As illustrated in FIG. 1, the web-based asset tracking management component 30 and the associated asset tracking dashboard is accessible via the 4G/5G network 84. The dashboard provides pallet and box status and location information to the owner of the shipped goods.

Note all communication paths illustrated in FIG. 1 are bidirectional.

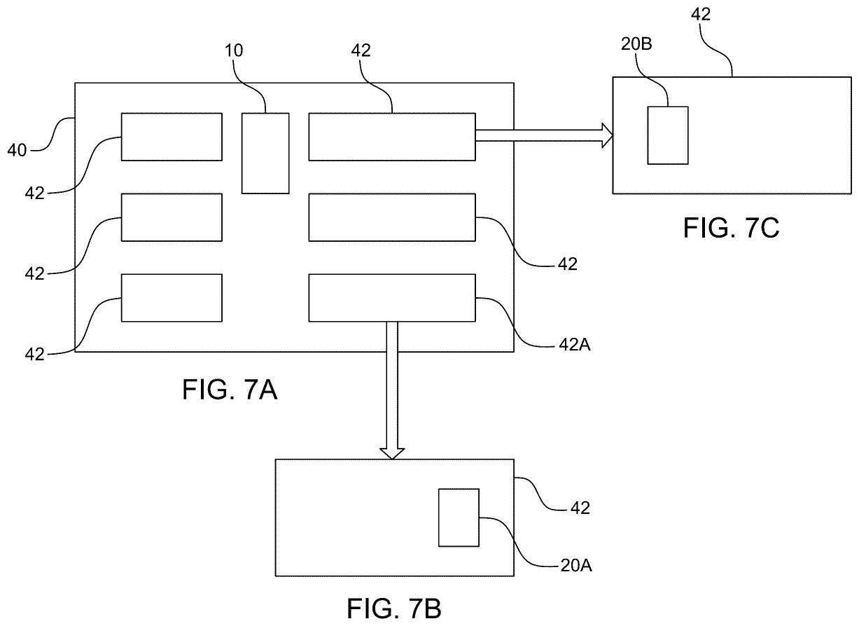

FIG. 7A illustrates, in block diagram form, a conventional shipping pallet 40 carrying a plurality of shipping boxes 42 (each including an enhanced box module 20A or a simplified box module 20B) and carrying the pallet module 10. See FIGS. 7B and 7C.

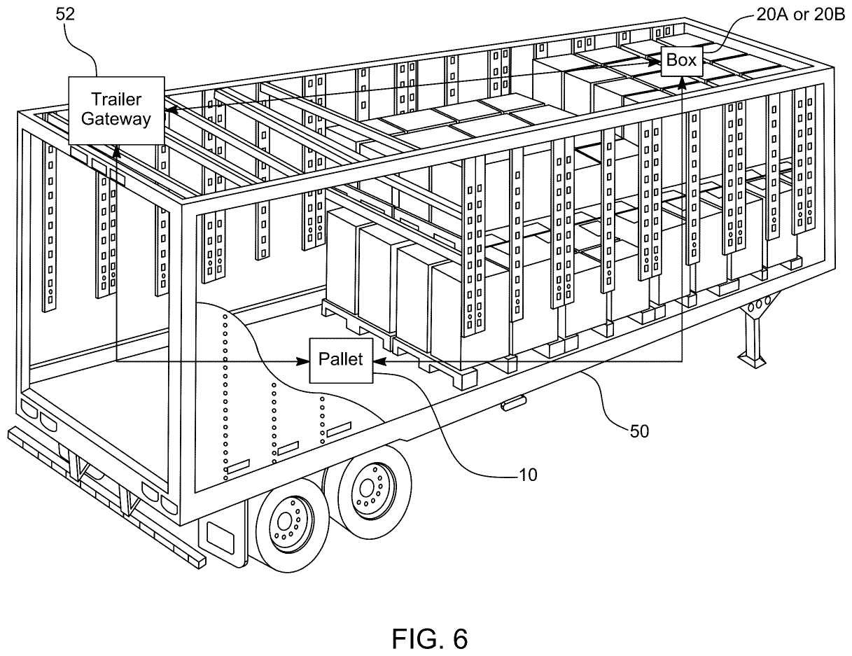

In one embodiment, a trailer 50 (see FIG. 6) includes the external WiFi gateway module 52 that provides signal connectivity to WiFi devices in the truck or trailer. The WiFi gateway module 52 can access the cellular 4G/5G network 84 while traveling on the road.

The pallet module and the enhanced and simplified box modules communicate with the web-based asset tracking management component 30 (or another web-based end point) by first establishing communications with the 4G/5G network according to one of the various communications paths depicted in FIG. 1.

FIG. 2 depicts details of the pallet module 10 including a system on a chip (SOC) master control unit 13, a battery 14, a memory 15, the Bluetooth interface 16, the 4G/5G interface 11, and the WiFi interface 12. A real time clock 80 can apply a current time annotation to any of the pallet module generated signals.

Sensors aboard the pallet module 10 comprise (in one embodiment) an accelerometer 60, a gyroscope 62, a humidity sensor 68, a temperature sensor 70, a barometric pressure sensor or barometer 71, and a weight sensor 72. One or more of these sensors provide input to the SOC master control unit 13 for determining movement of the pallet based on a differential temperature, pressure, etc. between first and second measured values where the first value is the temperature, pressure, etc. within the shipping trailer and the second value is the temperature, pressure, etc. outside this trailer. These two values may indicate the pallet was moved out from the trailer, and when coupled with additional information such as its intended destination, may indicate this movement occurred prior to the pallet reaching its destination.

As further illustrated in FIG. 2, the pallet module also includes a global navigation system 78 (GNSS) for determining a current location of the pallet.

Data collected by the sensors aboard the pallet and the pallet location is input to the asset tracking management component 30 either directly via the 4G/5G interface 11 and the 4G/5G network 84, or via the WiFi interface 12, the external WiFi gateway 52, and the 4G/5G network 84.

Although not specifically depicted in FIG. 2, each of the block diagram components communicates bidirectionally with the SOC MCU 13.

As illustrated in FIG. 3, the enhanced box module 20A includes a 4G/5G interface (transmitter/receiver) 21, a LAN interface (transmitter/receiver) 22, a system-on-a-chip (SOC) master control unit 23, a battery 24, and a memory 25. Although not specifically depicted in FIG. 3, each of the block diagram components of the enhanced box module communicates bidirectionally with the SOC MCU 23.

Note the enhanced box module, unlike the pallet module, lacks sensors in one embodiment. However in another embodiment, not illustrated, the enhanced box module includes sensors such as those depicted in FIG. 2 as elements of the pallet module 10.

The enhanced box module can report its location (as determined by the GNSS 76) via the LAN interface 22 to the WiFi interface 12 of the pallet module. But that WiFi connection can be established only if the enhanced box module and pallet module are within about 50 feet of each other. From the pallet module, the location of an enhanced box module is provided to the asset tracking and management component 30 (see FIG. 1) via the 4G/5G interface 11 and the 4G/5G network 84, or via the WiFi interface 12, the external WiFi gateway 52, and the 4G/5G network 84.

If the enhanced box module cannot close the WiFi link with the pallet module, then the enhanced box module and the pallet module have been separated by more than about 50 feet. Under this condition, the GNSS 78 on the pallet module and the GNSS 76 on the enhanced box module each determine their location and independently report that information to the 4G/5G network 84 (via one of the communication paths as set forth in FIG. 1) and thus to the asset tracking management component 30. The location information is displayed on the asset tracking dashboard. The cargo owner can determine if either or both of the enhanced box module and the pallet module have reached their destination or have been diverted.

As illustrated in FIG. 4, the simplified box module 20B contains only a Bluetooth interface (transmitter/receiver) 17 and a battery 24. The simplified box module 20B is paired with its host pallet module throughout the entire journey, that is, the Bluetooth interface 16 on the pallet module communicates with the Bluetooth interface 17 on the simplified box module. Specifically, the pallet module periodically monitors whether each simplified box module is paired via the Bluetooth link. When a simplified box module is no longer paired with the pallet module (that is, out of Bluetooth communications range) the pallet module sends an alert message to the asset tracking management component 30 via the 4G/5G connection interface. The message simply indicates that a simplified box module X (the identification number embedded in the alert message) is no longer within range of the pallet module Bluetooth signal. In one embodiment, the simplified box module 20B is embedded in a shipping label attached to the container or box.

The asset tracking management component 30, is essentially a cloud-hosted software program that resides at a web address on the internet, comprising software code 33 and a memory 35 (see FIG. 5) for storing the box and pallet information (including especially location) as supplied by the pallet and enhanced box modules.

The asset tracking management component 30 operates as the “brains” of the system, receiving and sending various signals to and from the pallet module (including signals based on the status of each box module) and the enhanced box module.

In one embodiment, the asset tracking management component 30 comprises cloud-hosted software that monitors the cargo during its journey. The software determines “good behavior” vs. “bad behavior” (for example, an unexpected location of a box before reaching its destination). The owner of the shipped goods or authorities are notified if “bad behavior” is detected via the dashboard 31.

In another embodiment, the decision-making process (that is, “good behavior” vs. “bad behavior”) is located at the “edge,” of the system, that is, each module (enhanced box module and pallet module) has the capability to determine its own fate (i.e., self-determination that it has been diverted before reaching the intended destination). In certain applications, this method may be deemed better than placing the decision-making process in the asset management component.

The signals transmitted by and received from the asset management component 30 relate to status, alert, query, control, and location of the pallet and enhanced box modules and are presented on the dashboard. This information and its display are available to the owner or transporter of the pallets and boxes by logging in to the cloud hosted software.

The asset tracking management component also receives sensor data (e.g., temperature, movement, motion, location) from the pallet module and, in one embodiment not illustrated, from the enhanced box modules. Under predetermined conditions, the sensor data may trigger an alert or notification as generated by the asset tracking management component. The notification is also displayed.

The SOC MCU 13 in the pallet module 10 (see FIGS. 1 and 2) and the SOC MCU 23 in the enhanced box module 20A (see FIG. 3) control operation of the components on their respective module.

The battery 14 in the pallet module 10 (see FIG. 2), the battery 24 in the enhanced box module 20A (see FIG. 3), and the battery 24 in the simplified box module 20B (see FIG. 4) each supply power to the components of its respective module.

Each box and pallet is assigned a unique identifier, such as an RFID serial number. The non-volatile memory 15 in the pallet module and the non-volatile memory 25 in the enhanced box module 20A store the unique identifiers and they are available to the user interface dashboard. The dashboard (i.e., associated with the asset tracking management component) can query the unique identifier stored in pallet module memory to associate that identifier with the actual unique pallet number (if needed to do so).

The various signals to and from the pallet, the enhanced box modules, and the simplified box modules include that unique identifier.

Initially, when cargo shipping boxes 42 of FIG. 7A (with either an enhanced box module 20A as in FIG. 7B or a simplified box module 20B as in FIG. 7C) are loaded onto a pallet 40 (that includes an embedded pallet module 10) at the origination location, each box module 20A/20B establishes a wireless connection with the pallet module 10. For the enhanced box module 20A, this connection is established between the WiFi interface 12 in the pallet module 10 and the LAN interface 22 in the enhanced box module 20A. For the simplified box module, this connection is established between the Bluetooth module 16 in the pallet module 10 and the Bluetooth interface 17 in the simplified box module 20B.

This connection is maintained throughout the trip until: a) the box module 20A or 20B and pallet module 10 are physically moved out of communications range from each other. If this situation occurs while the GNSS 78 in the pallet module or the GNSS 76 in the enhanced box module indicate a location other than the intended destination, this condition suggests an unauthorized removal of the box or pallet before arrival at its destination and a notification is issued to the asset tracking management component 30; b) the pallet module 10, the enhanced box module 20A, or the simplified box module 20B is intentionally turned off (i.e., because the box module 20A or 20B or pallet module 10 has reached its intended destination and the shipping receiver has powered these modules down or because the pallet or a box has been diverted from its intended destination and the thief has powered the modules down); or c) the battery in the enhanced box module, the battery in the simplified box module, or the battery in the pallet module has completely discharged.

If the pallet is loaded onto a trailer having a trailer gateway module 52, (see FIG. 1 or 6) each of the enhanced box modules 20A establishes a local wireless connection with the trailer gateway module 52 via the LAN interface 22 in each enhanced box module 20. Each of the pallet modules 10 also establishes a local wireless connection with the trailer gateway module 52 via the WiFi interface 12 in each pallet module 10.

Note that this WiFi communications path to the trailer gateway module 52 is a redundant path to the 4G/5G network, as each enhanced box module can also establish a direct communication path to the 4G/5G network using the 4G/5G interface in each enhanced box module. See element 21 of FIG. 3.

Also, each pallet module can establish a direct communications link to the 4G/5G network through the 4G/5G transmitter/receiver in each pallet. See element 11 of FIG. 2.

See FIG. 1, which also depicts the bidirectional wireless communications link between the enhanced box module 20A and the 4G/5G network 84, and between the pallet module 10 and the 4G/5G network 84.

Removal of the pallet 40 (and thus the pallet module 10 embedded in the pallet) from a stationary trailer 50 is detected when:
1) the pallet module 10 loses wireless connectivity with the trailer gateway module 52 (in those applications when the trailer includes a trailer gateway module 52), due to distance between the pallet module and the trailer module; or
2) an accelerometer 60 (see FIG. 1) and/or a gyroscope 62 embedded in the pallet module 10 detects abnormal or excessive movement of the pallet as it is removed from a stationary trailer 50; or
3) a humidity sensor 68 and/or a temperature sensor 70 and/or barometric pressure sensor 71 (see FIG. 2) embedded in the pallet module 10 detects movement of the pallet to a different location with a different temperature and/or a different humidity and/or a different barometric pressure from the temperature and humidity and pressure inside the climate-controlled trailer 50 of FIG. 6; or
4) the pallet module 10 detects a different location as determined by the GNSS 78 in the pallet module, as compared to the location of the trailer 50 as determined by a GPS device in the trailer or a GPS device in the semi-tractor or rig that moves the trailer.

Any one or more of these conditions triggers the pallet module 10 to send an immediate alert to the asset tracking management component 30 indicating detected movement of the pallet away from or out from the trailer 50. Based on the location of the pallet, as determined by the GNSS 78 in the pallet module 10, an algorithm executed by the asset tracking management component can determine whether the pallet is located at the correct location or destination.

Removal of an enhanced box module 20A from its host pallet is detected when:
1) the box module 20A loses wireless connectivity with the trailer gateway module 52 (in those applications where the shipping trailer includes a trailer gateway module 52); or
2) the enhanced box module 20A loses wireless connectivity with the WiFi interface 12 in the pallet module 10 (typically embedded in the pallet on which the box was setting); or
3) the pallet module 10 detects a decrease in pallet weight as determined by a weight sensor 72, see FIG. 2. In this case the pallet module knows “something” was removed from the pallet, but must await more data to determine what was removed. This data is determined by identifying which wireless link is no longer active (for example responsive to a query signal) i.e., a WiFi link for an enhanced box module 20A or a Bluetooth wireless link for a simplified box module 20B). The system then determines which box (which identification number) is associated with the inactive link.
4) the enhanced box module 20A determines its location using the GNSS device 76 (see FIG. 3). If the enhanced box module cannot connect to the pallet module 10, the enhanced box module reports its location to the asset tracking management component 30 where the location is compared to a GNSS position of the stationary pallet module as determined by pallet module GNSS device 78 (see FIG. 1). If the locations differ, then the box has been removed from the pallet and may have been diverted from its intended destination.
5) the enhanced box module has different location than the trailer location with both locations input to the asset tracking management component 30.

Any one or more of these conditions triggers the enhanced box module 20A to send an immediate alert to the asset tracking management component 30 indicating detected separation of the box from the pallet. Based on the location of the enhanced box module 20A, as determined by the GNSS 76 in the enhanced box module, an algorithm executing on the asset tracking management component determines whether the box carrying the enhanced box module is located at the correct location or destination. And certain of these conditions indicate diversion of the box carrying the enhanced box module before reaching its destination.

Removal of a simplified box 20B from its host pallet is detected when:
1) the host pallet module 10 (embedded in the pallet on which the box was setting) losses connectivity with a simplified box module 20B. The loss of connectivity is detected during periodic interrogations of the simplified box modules by the pallet module;
2) the pallet module 10 detects a decrease in pallet weight as determined by a weight sensor 72 (see FIG. 2). Like the above-described situation, the pallet module knows “something” was removed from the pallet, but must await more data to determine what was removed. This data is determined by identifying which Bluetooth wireless link to a simplified box module 20B is no longer active (for example responsive to a query signal). The system then determines which box (that is a box associated with a simplified box module) is associated with the inactive link.

Any one or more of these conditions triggers the pallet module 10 to send an immediate alert to the asset tracking management component 30 indicating that a box carrying a simplified box module has been removed from its host pallet.

In addition to displaying relevant information on the associated dashboard, the asset tracking management component 30 sends either an email and/or and a text message to the owner or transporter of the goods. The owner replies with either an affirmative or negative answer as to whether this removal is okay or is not okay based on received location information.

Upon confirmation by the asset tracking management component 30 that the removal of either a pallet or an enhanced box was unauthorized or unexpected, operation of the subject module (that is, the pallet module or the enhanced box module) transitions to a tracking mode, allowing for either: 1) active tracking where the module (pallet or box) transmits its current position at a configurable fixed interval with that position determined by the GNSS device 78 in the pallet module 10 (see FIG. 1) or by the GNSS device 76 in the enhanced box module 20A (see FIG. 2); or 2) covert tracking where the module (pallet or box) transmits its current position only when queried by the asset tracking management component. In either case, both the pallet module 10 and the enhanced box module 20A report their respective location via the 4G/5G cellular interface within 3 minutes, and with GNSS accuracy of better than 10 feet.

Upon unauthorized removal or diversion of a box or pallet, the owner of the goods will forward the location information to law enforcement. According to another embodiment, the asset tracking and management component automatically forwards position updates directly to law enforcement.

During normal shipping operations (that is, no cargo is removed until arrival at its destination), in one embodiment both the pallet module and the enhanced box module do not transmit their position over the cellular network unless queried by the asset tracking management component 30. This allows for battery conservation, sufficient for extended durations, and saves the battery capacity for when (or if) it is needed. When the modules reach their destination with no incidents, the module batteries are recharged and available for the next trip.

Note that the terms WiFi, LAN, and WLAN are used interchangeably herein, where LAN and WLAN refer to a wireless local area network and WiFi is a specific WLAN technology based on IEEE standard 802.11.

What is claimed is:

1. A cargo management system for tracking a pallet and containers carried on the pallet, the system comprising:
an asset tracking management software application;
a pallet module disposed on or proximate to the pallet;
the pallet module comprising a pallet communications device for sending pallet notifications to the asset tracking management software application, the notifications representative of a pallet status;
a global navigation satellite system for determining a current location of the pallet module, wherein the pallet status comprises a current pallet location;
the asset tracking management software application for receiving the current pallet location and for determining if the current pallet location is a proper pallet location; and
wherein a user accesses the asset tracking management software application to check the current pallet location.

2. The cargo management system of claim 1, wherein the proper pallet location comprises an intended destination for the pallet or comprises an en route location to the intended destination.

3. The cargo management system of claim 1, further comprising a plurality of containers on the pallet, wherein each container comprises a container module affixed to or within the container;
the pallet communications device for transmitting one or more interrogation signals for receiving by each container module and for receiving a return signal from container modules that are within communication range; and
for determining container modules that are not within communication range based on lack of a return signal, and thereby container modules that are not on the pallet.

4. The cargo management system of claim 3, wherein the interrogation signal is transmitted to each one of the containers over a Bluetooth communications link or a WiFi communications link.

5. The cargo management system of claim 1, further comprising a plurality of sensors within the pallet module or disposed on or proximate to the pallet, each one of the plurality of sensors for detecting a sensed condition of the pallet and for sending a sensor signal representative of the sensed condition to the pallet module, and wherein the sensed condition may be indicative of motion or movement of the pallet, and wherein responsive to the sensor signal, the pallet communications device transmits a notification signal to the asset tracking management software application, and wherein the notification signal received at the asset tracking management software application prompts further investigation to determine whether a pallet or a container carried by the pallet has been diverted before reaching an intended destination.

6. The cargo management system of claim 5, wherein the plurality of sensors further comprises a weight sensor for producing a sensor signal representing a current pallet weight, and wherein the pallet notification signal indicates the current pallet weight.

7. The cargo management system of claim 5, wherein the plurality of sensors comprises one or both of an accelerometer for determining a change in acceleration of the pallet and a gyroscope for determining a change in orientation of the pallet, a sensor signal indicating a change in acceleration or a change in orientation, and responsive thereto the pallet communications device transmitting a pallet notification signal to the asset tracking management device.

8. The cargo management system of claim 1, wherein the pallet is transported on a shipping trailer comprising a location determining device for determining a current location of the shipping trailer, wherein the current pallet location is compared with a current location of the shipping trailer to determine if the pallet has been diverted from an intended destination.

9. The cargo management system of claim 1, further comprising a plurality of containers carried on the pallet, wherein each container comprises a location determining device for determining a current container location, wherein the current pallet location is compared to a current container location for determining if a container has been removed from the pallet or a container has been diverted before arrival at an intended destination.

10. The cargo management system of claim 1, wherein the asset tracking management software application comprises a dashboard display for displaying pallet notifications.

11. The cargo management system of claim 1, further comprising one or more of a temperature sensor, a humidity sensor, and a barometer each disposed within the pallet module or disposed proximate to the pallet for detecting movement of the pallet from a first location to a second location based on a temperature differential between the first and second locations as sensed by the temperature sensor, or based on a humidity differential between the first and second locations as sensed by the humidity sensor, or based on a pressure differential between the first and second locations as sensed by the barometer.

12. The cargo management system of claim 11, wherein the first location comprises aboard a shipping trailer.

13. The cargo management system of claim 1, wherein the asset tracking management software application is web-based, and wherein the pallet notification is transmitted from the pallet module via a 4G/5G/LTE interface directly to the asset tracking management software application or the pallet notification is transmitted from the pallet module to a serial configuration of a WiFi interface within the pallet module, an external WiFi gateway interface, and a 4G/5G/LTE interface to the asset tracking management software application.

14. The cargo management system of claim 13, wherein the pallets are carried by a shipping trailer and the external WiFi gateway interface is disposed on the shipping trailer.

15. The cargo management system of claim 1, wherein the system further comprises first container modules each one disposed on or proximate to a first container, and further comprises second container modules each one disposed on or proximate to a second container, wherein each one of the first container modules comprises a Bluetooth interface, and each one of the second container modules comprises a WiFi interface, the pallet module comprising a Bluetooth interface for communicating with the first container modules, and the pallet module comprising a WiFi interface for communicating with the second container modules.

16. The cargo management system of claim 15, wherein one or more of the second container modules comprises a global navigation satellite system for determining a location of the second container module, the second container module for providing a location signal representative thereof to the pallet module via the WiFi interface, the pallet module for providing the location of the second container module to the asset tracking management software application using the pallet communications device, or the second container module for providing the location signal directly to the asset tracking management software application without use of the pallet module.

17. The cargo management system of claim 1, further comprising containers carried by the pallet, the pallet module further comprising a first Bluetooth communications interface, and one or more of the containers comprising a second Bluetooth communications interface, the pallet module for interrogating each container by transmitting an interrogation signal from the first Bluetooth communications interface to each one of the second Bluetooth communications interfaces, a response signal from a second Bluetooth communications interface on a container indicating that the container received the interrogation signal.

18. A method for determining whether a pallet has been moved from a first location, the method comprising
a. determining one or more of a temperature, humidity, and pressure at a first pallet location at a first clock time;
b. determining one or more of a temperature, humidity, and pressure at the pallet at a second clock time;
c. determining whether one of a temperature, humidity, and pressure at the pallet at the second clock time is different from a respective temperature, humidity, and pressure at the pallet at the first clock time; and
d. determining that the pallet has been moved from the first location responsive to step c.

19. The method of claim 18, further comprising:
e. determining whether a gyroscope mounted on the pallet or an accelerometer mounted on the pallet indicate movement of the pallet; and
f. determining that the pallet has been moved responsive to the indication of movement by the gyroscope or by the accelerometer.

20. A method for determining that a container has been removed from a pallet carrying a plurality of containers, the method comprising:
a. determining a first weight of the pallet at a first clock time;
b. determining a second weight of the pallet at a second clock time;
c. determining a differential between the first weight and the second weight; and
d. determining that a container has been removed from the pallet based on a non-zero differential.
